(19) United States
(12) Patent Application Publication
(10) Pub. No.: US 2026/0112156 A1
(43) Pub. Date: Apr. 23, 2026

(54) MULTI-STAGE LONG VIDEO UNDERSTANDING

(71) Applicant: Lemon Inc., Grand Cayman (KY)

(72) Inventors: Guang Chen, Los Angeles, CA (US); Dawei Du, Los Angeles, CA (US); Fan Chen, Los Angeles, CA (US); Longyin Wen, Los Angeles, CA (US); Ye Yuan, Los Angeles, CA (US); Wen Zhong, Los Angeles, CA (US); Sijie Zhu, Los Angeles, CA (US); Chia-Wen Kuo, Los Angeles, CA (US); Ziaohui Shen, Los Angeles, CA (US)

(21) Appl. No.: 18/922,569

(22) Filed: Oct. 22, 2024

(51) Int. Cl. G06V 10/82; G06F 40/284; G06V 10/778

(52) U.S. Cl. CPC G06V 10/82; G06F 40/284; G06V 10/778

(57) ABSTRACT

Methods, systems, and apparatus, including computer programs encoded on computer storage media, for long video understanding. One of the methods includes obtaining a video; extracting frames from the video; encoding the extracted frames; extracting multimodal features including encoding speech content from the video as a text modality; encoding spatiotemporal dependencies between the extracted frames and aligned multi-modal features; providing the encoded temporal dependencies to a language model (LM) that learns spatiotemporal understanding of the entire video content; and using the language model to respond to user queries about the content of the video.

### BACKGROUND

This specification relates to using machine learning techniques to process video data. Video sharing platforms have become more and more popular. While many videos are short-form videos, e.g., having a length of less than one minute, there are also long form videos that can be significantly longer from tens of minutes to hours in length. An example type of long form video that has become increasingly popular is an “explainer” video in which users create one or more long form videos to explain a particular topic. In particular, explainer videos are common with respect to entertainment content, e.g., explanatory videos related to movies, TV shows, documentaries, variety shows, etc.

### SUMMARY

This specification describes technologies for generating a comprehensive semantic understanding of long form video content. A multi-stage multi-modal long video understanding model is provided that achieves a comprehensive and deep understanding of input videos. The resulting understanding can be used to respond to various downstream tasks. For example, in response to queries the model can generate summaries of the video content as well as generate responses to queries about the content of the video. The model improves the accuracy, generalization ability, and adaptability in various video understanding tasks and scenarios.

The model uses training data collected from various tasks and uses the different data sets alone or in combination to train a variety of scenarios and increase the adaptability of the model. Consequently, a number of individual tasks can be effectively trained using a small portion of the overall data, reducing data dependence. Additionally, during training the model is exposed to a number of different scenarios, which improves the robustness and versatility of the model.

Typical machine learning models can have difficulty with longer temporal content in that they often have increased difficulty in associating meaning when separated by larger temporal distances. For example, for a longer video there may be thousands of frames. A conventional model can forget learned information from earlier in the video by the time later frames are analyzed. This can lead to inconsistencies in the understanding of the video. The provided model integrates time processing techniques that ensure time consistency and accurately captures long-distance dependencies in a video sequence.

The model has a flexible framework that allows for seamless integration of new data and new tasks. This adaptability ensures that the model can quickly integrate new components and respond to changing needs without extensive reconfiguration or redesign of the model.

Conventional video understanding techniques typically focus on a single modality of input, e.g., the video content only without audio or text elements. By contrast, the model described in this specification provides a multi-modal machine learning model that combines visual, auditory, and textual data. This multi-modal learning capability allows the model to understand video content containing information of various formats, which improves accuracy and context-aware video analysis.

The model uses distributed computing and multi-task training techniques that allow for multiple video understanding tasks to be trained simultaneously. This not only improves training efficiency, but also allows for parallel iteration on different tasks. As a result, the model can be continuously improved with additional training.

Using the above innovative features, the model can achieve a higher accuracy in video understanding tasks as compared to conventional models. In addition, the model provides a deeper understanding of the relationship between different modalities and video editing tasks, thereby enhancing the model's versatility and generalization ability. The model provides a powerful and adaptable tool for comprehensive video analysis, meeting a wide range of application needs.

In general, one innovative aspect of the subject matter described in this specification can be embodied in methods that include the actions obtaining a video; extracting frames from the video; encoding the extracted frames; extracting multimodal features including encoding speech content from the video as a text modality; encoding spatiotemporal dependencies between the extracted frames and aligned multi-modal features; providing the encoded temporal dependencies to a language model (LM) that learns spatiotemporal understanding of the entire video content; and using the language model to respond to user queries about the content of the video. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system flow for video understanding.

FIG. 2 is a diagram of an example model architecture for video understanding.

FIG. 3 is a diagram illustrating an example of using hierarchical attention mechanisms to learn temporal dependencies.

FIG. 4 is a diagram of an example model training flow.

FIG. 5 is a block diagram of an example computing system that can be used in connection with computer-implemented methods described in this specification.

Like reference numbers and designations in the various drawings indicate like elements.

### DETAILED DESCRIPTION

This specification discloses technologies for training and implementing a multi-modal video understanding model.

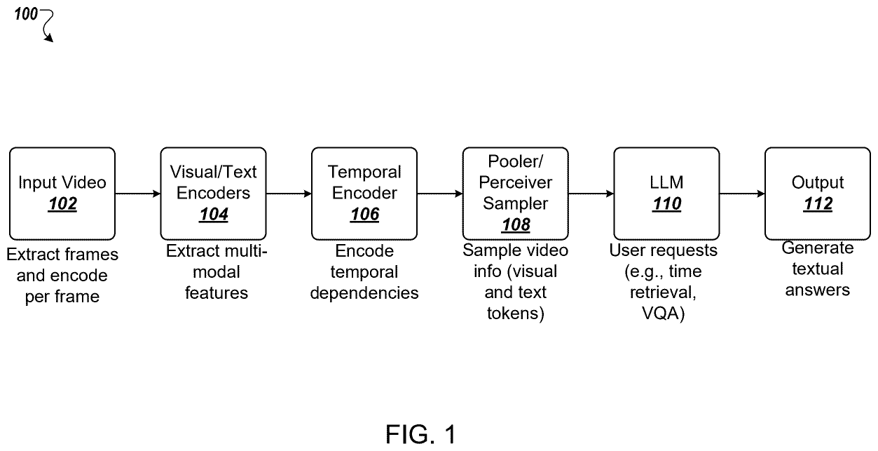

FIG. 1 is a diagram of an example system flow 100 for video understanding. For convenience, the system 100 will be described as being performed by a system of one or more computers, located in one or more locations, and programmed appropriately in accordance with this specification.

The system obtains input video data (102). The video data, which for simplicity can simply be referred to as a “video” can be of a sequence of video frames along with associated audio and, optionally, textual content. The number of video frames typically depends on the length of the video, e.g., based on a specific frame rate of video capture. Thus, long form videos of length in the minutes or hours can have a large number of video frames. Processing all of the frames in long videos can lead to situations where the system memory is insufficient to handle all of the frames. Instead, the system samples the video in a defined manner to extract a collection of frames for processing. For example, in some implementations, the sampling is simply performed at a fixed frequency, e.g., one frame per second or one frame every two seconds. For example, a device may have captured the video content at frame rate of 30 frames per second (fps). Sampling at a fixed frequency of one frame per second would therefore mean one frame out of every 30 frames is sampled. In some implementations, the sampling frequency is set based on the total number of frames (or frames per scene as described below). For example, there may be a max number of frames set for the model and the frequency can have an upper limit set based on the number of frames and this maximum, e.g., 2048 maximum frames.

In some implementations, the video is first processed using scene detection techniques to identify each individual scene within the video. The scene detection techniques can, for example, identify transitions within the video. A transition might be based on one or more solid black frames separating scenes or one or more scene transition effects, e.g., a wipe or slide effect. A transition may also be detected based on a change in the features between frames. For example, frames within a scene may share a number of similar features while a next scene may have different features. By analyzing the content of the frames, the transitions between scenes can be detected.

Once separated into scenes, each scene can have a fixed frequency of frames extracted. In some alternative implementations, for each scene one or more keyframes are identified and extracted. In many videos, there are a large number of frames that are similar to other frames. Consequently, sampling a subset of frames for each scene generally does not lead to a loss of content. In some implementations, the sampling frequency may be different for different scenes. For example, self-adaptive sampling can be applied on a scene by scene basis to adjust the sampling frequency based on the content and length of each frame. In some implementations, the sampled frames are downsampled in a way that preserves important information but reduces frame size.

In some implementations, short videos having a specified number of frames or fewer can use all frames instead of sampling a subset of frames. Since the small number may not overextend the resource capabilities, e.g., memory, all frames can be processed. Alternatively, a different fixed frequency can be selected for short videos vs. longer videos, for example, short videos can have a fixed frequency of sampling one frame per second of video vs. one frame ever three seconds for a very long video.

The system extracts multi-modal features using visual and text encoders (104). For the selected frames, whether all of the frames in short video or a sampling of frames for a long video, the system uses a visual encoder to generate a corresponding tokenized representations. Each frame is processed to extract visual features and encode the visual features into tokens.

The speech from the video can be used to generate a text modality. In some implementations, a transcription of the speech is included in the video. In some other implementations, a speech to text process is performed to extract text from the audio speech of the video. A text encoder turns the speech text into a set of tokens. Each token represents a unit of text, which can be a word, phrase, or simple punctuation.

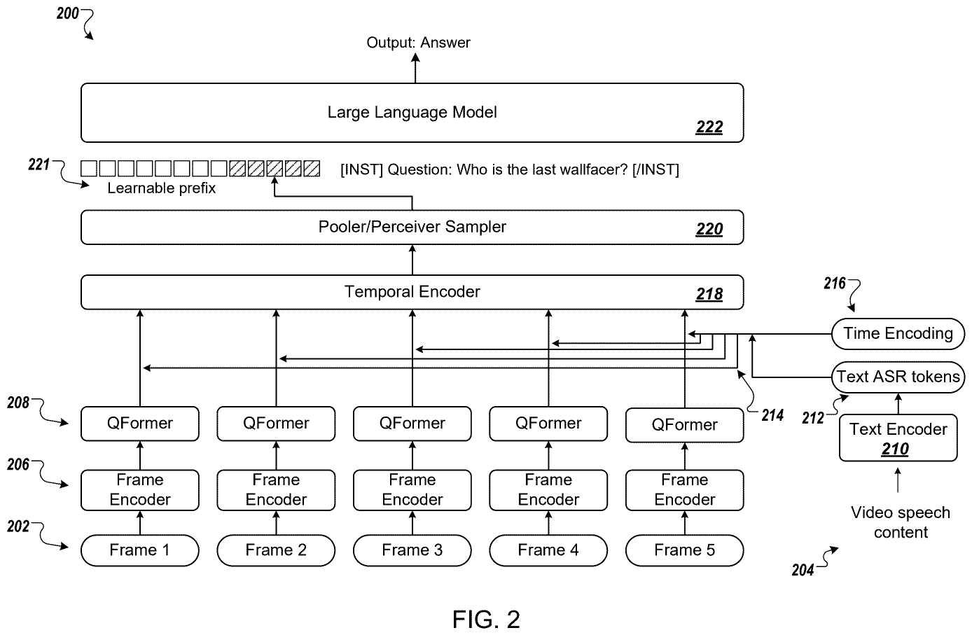

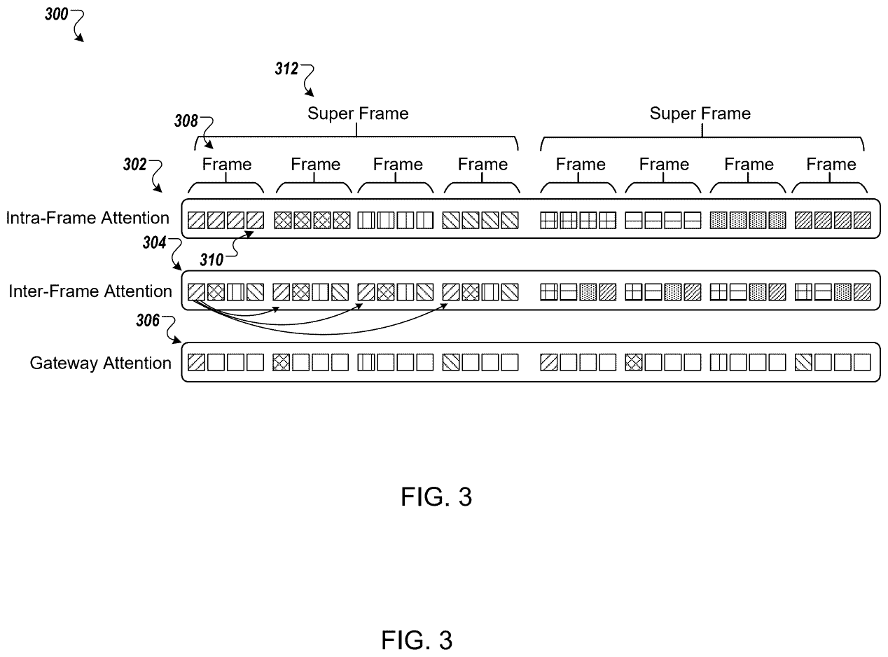

The system encodes temporal dependencies (106). The multimodal information, i.e., visual modality and text modality, are aligned and fused before performing temporal modeling. This includes using image frame and speech timestamp information as part of the respective encodings. The corresponding visual and speech tokens can then be spliced based on the timestamp information. The aligned tokens are used by the temporal encoder to learn video spatiotemporal context information. The temporal encoder can be based on a hierarchical attention mechanism, which will be described in greater detail below with respect to FIGS. 2-3.

Language model can be used to process the output of the temporal encoder, in some implementations, a large language model (LLM) is used to process the output of the temporal encoder and generate a natural language output. The system adapts the output of the temporal encoder for input to the large language model (LLM) (108). In some implementations, a neural network is used to convert the space where each token is located to a space where the LLM text token is located. Conceptually, this can be considered as a projection from the visual and audio modalities to the LLM modality.

The system provides the adapted output to the LLM along with one or more downstream tasks (110). The tasks can relate to particular prompts for the LLM to generate an output based on the input multi-modal video understanding. For example, the task can relate to one or more of describing video content, summarizing storylines, time retrieval (e.g., returning or describing content at a particular timestamp of the video), or video question and answer (Q&A) (e.g., generating textual responses to user queries about the content of the video).

Based on the task defined by the prompt, the LLM generates a natural language output to the prompt (112). For example, a time-related video Q & A prompt may ask who appears in the video at a particular time, e.g., at 23 minutes from the start of the video. The output response of the LLM identifies one or more individuals appearing in the video at that timestamp.

FIG. 2 is a diagram of an example model architecture 200 for video understanding. The inputs to the model include the sampled frames 202 and video speech content 204. Each sampled frame can have a respective processing flow until combined later in the model. The sampled frames are selected as described above with respect to FIG. 1.

Each input video frame 202 is processed by a corresponding frame encoder module 206. The frame encoder module 206 extracts features from each video frame and encodes the features into tokens. For example, a transformer-based visual encoder can be used to calculate visual features and encode them into tokens. In some implementations, the video encoder uses Vision Transformer (ViT) to encode the images. The Vision Transformer divides each input video frame into a sequence of fixed-size non-overlapping patches, which are then linearly embedded. The resulting sequence is fed into a transformer model having a number of attention layers that calculate correlations between patches to generate a set of tokens representing the semantic information of the content of the frame.

The generated tokens from each frame are fed into a corresponding querying transform (QFormer) module 208. The QFormer module 208 is a transformer based neural network model that can be used to reduce the number of tokens for each frame while maintaining the semantic information. For example, if the frame encoder module 206 encodes each frame with 256 tokens, the QFormer may reduce that number to 32 tokens without loss of semantic information. This greatly reduces the memory requirements for the model, enabling the model to learn spatiotemporal context of long video content.

The QFormer generates dynamic queries based on the frame features encoded in the input set of tokens for the frame. Essentially, the encoded image is queried by the QFormer to extract relevant information from the image. The QFormer then generates an encoding, using a set of attention transformer blocks, having reduced dimensionality by generating a set of tokens that represent the semantic information most relevant to the dynamically generated queries. The reduction in tokens improves efficiency of the model 200, particularly for large numbers of video frames. However, in some alternative implementations, the QFormer is omitted and the encoded tokens from the frame encoder are used.

Returning to the speech content of the video, the speech content is encoded by a text encoder module 210 to generate a set of text tokens 212. The video speech content can include audio content as well as transcription content, i.e., speech transcription included with the video that transcribes the speech content. Automatic speech recognition techniques can be used to generate a text version from the audio speech. In some implementations, the automatic speech recognition is provided by a machine learning model that takes the audio content as an input to the model and outputs text strings predicted to correspond to the audio content. The text strings are broken into a set of tokens corresponding to the speech input. A token can correspond to a word, a phrase, individual punctuation, etc. An example ASR model is Whisper described in Radford et. al. “Robust Speech Recognition via Large-Scale Weak Supervision” arXiv:2212.04356v1 (2022).

Timestamp information is added to video frame encodings and the text encodings. A time encoding module 216 determines timestamps to add to each image encoding and to identify timestamp interval ranges for particular text portions. Adding timestamps aids in aligning the visual information with the text information. That is, matching the text to the corresponding image frames where the speech occurs. Adding timestamps also aids the model in solving complex video understanding editing tasks.

For each encoded image frame, two time encodings are added. The time encodings include an absolute value of a timestamp and a relative value of time percentage. The absolute value corresponds, for example, to a timestamp of the image frame at five minutes from the beginning of the video. The relative value of time percentage indicates what percentage of the entire video the frame occurs. For example, if the entire video is 50 minutes, then the relative value of time percentage is ten percent meaning that the frame occurs at a point when ten percent of the total video has elapsed. This provides information on where in the video the frame occurs that is not evident from the absolute timestamp alone. The image encoding can include position encoding information. Position encoding, for example, in text encoding, indicates the position of each text token, e.g., a location within a sentence. Similarly, images can have a position encoding indicating where in the video the frame occurs. The time encodings are added by adjusting a sinusoidal function hyperparameter of the position encoding to encode the absolute position and relative position timestamps respectively.

The video can include subtitle information, providing an additional modality to the image and speech content. Software called SubRip can be used to extract the subtitles and their timings from the video content. The corresponding SRT file format provides a time range for the appearance of the subtitle, which corresponds to the timestamp range, and the corresponding subtitle text presented in that time range. The timestamps ranges can be input into the text encoder 210 for direct encoding of the time information corresponding to the text.

The timestamp encoding is used to distinguish between different image frames. During the temporal encoding, dependencies between frames are learned. Knowing where the frames exist in relation to each other aids in calculating the dependencies.

A fusion operation (214) splices the timestamp encoded text tokens with the timestamp encoded image tokens from each QFormer module 208 prior to temporal modeling by the temporal encoder 218. In practice, after extracting tokens from multiple image frames, video semantic recognition information is extracted between frames as text information and image information fusion. A token splicing method of the text and image tokens is used for fusion. The fused information is used as single-frame multi-modal information that is input to the temporal encoding module 218.

The aligned and timestamp encoded tokens corresponding to the video frames and the speech text are input to the temporal encoder module 218. The temporal encoder module 218 uses a hierarchical attention mechanism to learn dependencies between the tokens. In some implementations, a three-layer attention mechanism is used to avoid unnecessary correlation learning, which can greatly reduce complexity. The attention mechanism will be described with respect to FIG. 3.

FIG. 3 is diagram 300 illustrating an example of using hierarchical attention mechanisms to learn temporal dependencies. The hierarchical attention mechanism includes three layers: intra-frame attention 302, inter-frame attention 304, and gateway attention 306.

During intra-frame attention 302, the tokens, e.g., token 310, of each frame 308 are used to calculate correlations with each other token of the frame. Each frame is represented by a set of tokens. Based on the calculated correlations, a respective fused token can be used to represent the semantic contents of each frame.

During inter-frame attention 304, the correlation between different frames 308 is calculated. To calculate the correlation between different frames, a multi-frame image can be defined as a super frame 312 composed of a set of adjacent frames. In the example shown in FIG. 3, each super frame 312 is composed of four frames, though in other implementations different numbers of frames can be used, e.g., eight. In particular, the inter-frame attention can limit the correlation calculation to tokens in the same position between frames. In other words, the correlation calculation for a token in the first position of the first frame of the super frame is performed with respect to tokens in the first position of the other frames of the super frame. This reduces necessary dependency calculations between tokens at different positions.

During gateway attention 306 the correlations between different super frames are calculated. Similar to the inter-frame attention, the calculation can be based on the correlation between tokens at the same position in different super frames. In particular, each frame can be represented by a single token. The correlations are then calculated between these individual frame tokens within the super frame.

This hierarchical attention learning mechanism allows the model to balance computational efficiency and attention learning, effectively capturing local and global contextual information of the video. It is additionally noted that inter-frame timestamp encoding needs to be considered in the time encoder 216 to represent the time distance between frames. The timestamp encoding information can be treated as position information in the time domain as an extension of position embedding techniques such as Rotary Position Embedding (RoPE).

The temporal encoder module 218 may be configured as a hierarchical set of transformer layers, where each transformer includes a set of attention-based encoder layers. For example, a first transformer layer can perform the intra-frame attention. The output of the first transformer layer can be used as input to a second transformer layer that performs the inter-frame attention. The output of the second transformer layer can be used as input to a third transformer layer that performs gateway attention.

For a given transformer layer, a set of attention layers can be used to calculate the respective correlations. The encoded video tokens are input to the transformer layer, which contains a set of encoder layers. Each encoder layer can have the same architecture. However, each encoder can have a different set of parameter values as a result of the training of the attention neural network. Each encoder layer can include, for example, an attention layer and a feed forward layer. In the first transformer layer, the attention layer determines relationships between tokens of each individual video frame. Various suitable forms of attention can be used. Each feed-forward layer processes the attended tokens to generate an output of the encoder layer, which can then be input to the next encoder layer.

The output encoding of the first transformer layer, corresponding to the understanding of the content of each frame, is fed into the second transformer layer that again has a set of encoder layers. However, the attention layers of the second transformer layer are focused on understanding the relationship between different frames.

Similarly, the output encoding of the second transformer layer, corresponding to the understanding of the relationship between adjacent frames, is fed into the third transformer layer that again has a set of encoder layers. However, the self-attention layers of the third transformer layer are focused on understanding the relationship between different super frames.

Returning to FIG. 2, the output from the temporal encoding module 218 is provided to a pooler/perceiver sampler model 220. The pooler/perceiver sampler model 220 modally aligns the output information with the large language model (LLM) 222 so that the encoded spatiotemporal information can be integrated into the LLM. In some implementations, a two layer neural network is used to convert the space where the token is located in the spatiotemporal encoding to the space where a corresponding LLM text token is located. The two layer neural network is trainable to adapt the encoded information into the LLM. In some implementations, end-to-end training of the neural network is performed based on large scales of datasets. Thus, the two layers can be trained as a good transformation from encoded visual-textual features to LLM text tokens.

LLMs are a class of machine learning models designed to understand and generate human-like text based on vast amounts of data. These models are built using deep learning techniques, particularly variants of transformer architectures. Large Language Models are used for various natural language processing tasks, including text generation, translation, summarization, sentiment analysis, question answering, and more.

The LLM 222 receives the converted multi-modal video understanding along with one or more editing tasks 224, e.g., different types of prompts associate with particular uses of the LLM with respect to video including describing video content, summarizing storylines, time retrieval, video Q&A, etc.

In some implementations, a pretrained LLM, is used to process the multi-modal input and generate text answer output 226. However, any suitable LLMs may be used. The pretrained LLM can be a large language model trained by a third-party system. The third-party system can include one or more computing devices, such as one or more servers or multiple distributed computing devices. The pretrained LLM can be trained on a massive amounts of text data to understand and generate human-like text. These models have been used for various NLP tasks, including text generation, translation, summarization, and question answering. They are capable of understanding context, syntax, and semantics in human language and generating coherent and contextually relevant responses to given prompts. In some implementations, the pretraining process involves exposing the model to a wide range of language patterns and contexts, allowing it to learn the nuances of syntax, semantics, and grammar. Through self-supervised learning tasks like language modeling and next-word prediction, the LLM model learns to generate coherent and contextually relevant text responses to given prompts.

The LLM can be fine-tuned to the particular downstream tasks of the video understanding. Fine-tuning typically involves further training the pretrained LLM on a smaller, task-specific dataset to optimize its performance for the intended application. In some implementations, to perform parameter efficient fine-tuning on the pretrained LLM, learned vectors are added into the pretrained LLM. For example, the learned vectors are added into the attention and feedforward modules of the LLM. These learned vectors are the only trainable parameters during fine-tuning. The parameter efficient fine-tuning adds or updates as few parameters as possible to avoid incurring storage and memory cost. Additional details on fine tuning the LLM are described below with respect to model training.

For example, prompt tuning can be used to fine-tune the LLM. Specifically, for each downstream task (such as video description generation, video content retrieval), the system separately learns a set of short prompt words (learnable prefix prompt 221). This achieves very efficient alignment and extremely low training cost while fixing most LLM parameters. The learnable prefix prompt 221 can be represented as a vector that has the same dimension of the input received from the pooler/perceiver sampler 220. By using the learnable prompt, or vector, the system can gradually integrate the multi-modal understanding ability into the LLM. Using the learnable prompt also improves training of the LLM, described below, because only a small number of hyperparameters are trained during this learnable prompt training.

In use, the LLM generates natural language answers to questions received from one or more users for a given video content. Having understood one or more videos input to the model, the LLM is able to respond to user queries about the understood videos including long form video content. Users can submit queries seeking summary or content description of a video, information about content occurring at a particular time in the video, etc. Other times of queries associated with other downstream tasks can be trained.

### Model Training

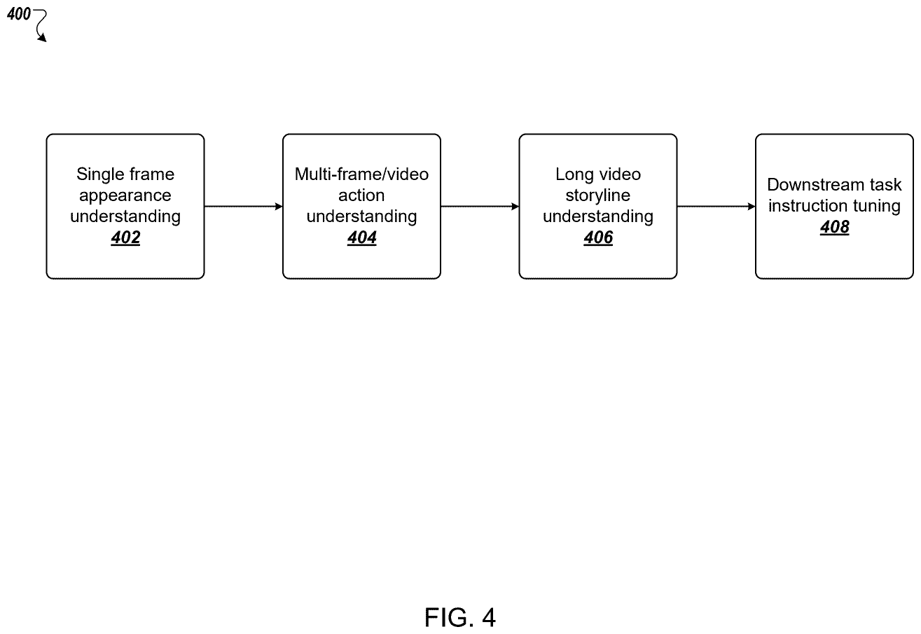

FIG. 4 is a diagram 400 of an example model training flow. As shown in FIG. 4, a four stage training process can be used to train the model to learn to understand long videos. The training process imitates the way humans understand videos. The progressive training process at each stage aligns multiple modalities in order of difficulty from less difficult to more difficult to ensure that the model obtains the understanding ability and training stability of each stage.

The first training stage is single frame appearance understanding 402. During single frame appearance understanding, the main task of the training is to align images and text pairs, for example, an image and a corresponding content description. The training allows the model to learn the spatial semantic understanding of single-frame images. The image descriptions in the training images typically focus on features of the image such as color, shape, position, people and objects, etc. For example, an image and corresponding description can include a boy wearing blue clothes in the picture, and the background containing a street. In some implementations, to obtain the training data set, a collection of image-text pairs are obtained and re-labeled. The training set can include a wide variety of scenes and themes. In some other implementations, a suitable training set can be obtained without need to re-label the content descriptions.

The second training stage is multi-frame/video actions understanding 404. When the semantic alignment of the single frame image is completed, the next stage of model training works to recognize the actions and events of a multi-frame sequence. Specifically, in this stage, the main task is to complete the alignment of video and text pairs, for example, video content description. In order to better adapt to the middle-level semantic alignment, the training uses the high-quality graphic and text pairs of the previous stage to establish a simulated video (synthetic video) to assist training. Specifically, the simulated video content of the training data is generated by randomly selecting K frames of images, making a random number of copies and image enhancements to each frame, and adding pseudo timestamps to form a simulated sequence of frames forming a video. After aligning the simulated video with the corresponding text description, real video data is added for training and transfer of the model's ability to recognize timestamps. In this way, the model can describe actions with temporal information on video content. For example, the model describes a kid in blue riding a bike across the street at a specific timestamp e.g., 3 minutes and 12 seconds into the video.

The third training stage provides long video storyline understanding 406. When the model has the ability to understand the shallow video, it can learn the deep understanding ability of the plot of the video story. At this stage, the main task is to complete the alignment of the video and plot text. This stage is not only limited to shallow understanding, but also emphasizes the understanding of plot design, character interaction, and story themes. For example, the model describes a boy in blue who is late for school because he woke up late. He is riding his bike to school and crossing the street at 3 minutes and 12 seconds. Based on the video dialogue text, a generative LLM can be used to generate chapter summaries of each video clip, outlining the main time and character dynamic information that occurs in the clip, thus providing a structured summary of the story plot. In some implementations, the training data is composed of video data that comes, for example, from tutorial video datasets, which can contain rich dialogue text information to identify key elements in the video plot, helping to generate accurate chapter summaries.

The fourth training stage is downstream task instruction tuning 408. This training teaches the model how to respond to instructions from a user. After the model completes multi-level semantic alignment, a set of instruction templates are configured for various downstream tasks of video understanding. Creating instruction templates for downstream tasks allows the model to understand user instructions, including video plot retrieval, story description, and chapter summary. For example, a time retrieval query can be a natural language query requesting a point in the video where some event occurred. The output of the LLM would be a timestamp responsive to the query. In another example, the query can be a user request to summarize the contents of the video. The LLM model output would be a text description summarizing the video content. Each of these types of queries can be associated with a respective instruction template.

An existing LLM can be used to generate the instructions for downstream tasks. For example, a high-performance LLM can be used to perceive video content to generate high-quality instructions. In some implementations, the high-performance LLM may not be configured to process visual information. In such cases, the system can provide detailed video descriptions and dialogue text from a set of training data are provided to the high-performance LLM to compensate. In this way, such an LLM can still obtain a comprehensive understanding of the video from the visual details in the video description and the deep semantics in the dialogue text. The instruction following stage can greatly improve the model's versatility and generalization ability.

In this specification, the term “database” is used broadly to refer to any collection of data: the data does not need to be structured in any particular way, or structured at all, and it can be stored on storage devices in one or more locations. A database can be implemented on any appropriate type of memory.

In this specification the term “engine” is used broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

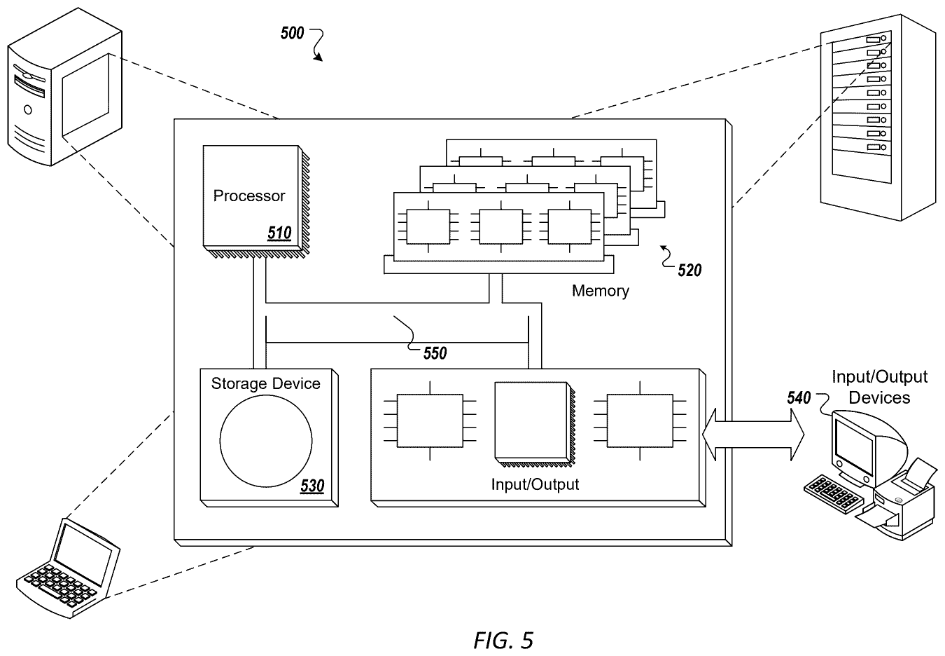

An example of one such type of computer is shown in FIG. 5, which shows a schematic diagram of a computer system 500. The system 500 can be used for the operations described in association with the implementations described herein. For example, the system 500 may be included in any or all of the components of the video understanding model discussed in this specification. The system 500 includes a processor 510, a memory 520, a storage device 530, and an input/output device 540. The components 510, 520, 530, and 540 are interconnected using a system bus 550. The processor 510 is capable of processing instructions for execution within the system 500. In some implementations, the processor 510 is a single-threaded processor. The processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. The memory 520 can be a volatile memory unit or a non-volatile memory unit. The storage device 530 is capable of providing mass storage for the system 500. The storage device 530 is a computer-readable medium. The storage device 530 may be a floppy disk device, a hard disk device, an optical disk device, or a tape device. The input/output device 540 provides input/output operations for the system 500. The input/output device 540 includes a keyboard and/or pointing device. The input/output device 540 includes a display unit for displaying graphical user interfaces.

In addition to the embodiments of the attached claims and the embodiments described above, the following embodiments are also innovative:

Embodiment 1 is a method, the method comprising: obtaining a video; extracting frames from the video; encoding the extracted frames; extracting multimodal features including encoding speech content from the video as a text modality; encoding spatiotemporal dependencies between the extracted frames and aligned multi-modal features; providing the encoded temporal dependencies to a language model (LM) that learns spatiotemporal understanding of the entire video content; and using the language model to respond to user queries about the content of the video.

Embodiment 2 is the method of embodiment 1, wherein extracting frames from the video comprises separating the video into a plurality of scenes and sampling one or more frames from each scene.

Embodiment 3 is the method of any one of embodiments 1 through 2, wherein encoding the extracted frames comprises, for each frame: applying a visual encoder to encode the frame into a set of tokens; and applying a query transformer to generate a representation of the frame encoding having a reduced number of tokens

Embodiment 4 is the method of any one of embodiments 1 through 3, further comprising: adding timestamp information to each video frame encoding and text encoding of speech content, the video frame encoding including a first encoding indicating an absolute time associated with the video frame and a relative time indicating a location of the video frame relative to the entire video.

Embodiment 5 is the method of any one of embodiments 1 through 4, wherein encoding temporal dependencies comprises: applying a hierarchical attention model comprising: a first attention layer performing intra-frame attention that calculates correlations between tokens of a frame; a second attention layer performing inter-frame attention that calculates correlations between adjacent frames; and a third attention layer performing gateway attention that calculates correlations between adjacent super frames.

Embodiment 6 is the method of any one of embodiments 1 through 5, wherein providing the encoded temporal dependencies to the large language model further comprises: applying a neural network model that modally aligns spatiotemporal encoding tokens with LM text tokens.

Embodiment 7 is the method of any one of embodiments 1 through 6, wherein providing the encoded temporal dependencies to the large language model further comprises providing one or more editing tasks corresponding to user downstream tasks to the LM along with the encoded temporal dependencies.

Embodiment 8 is the method of any one of embodiments 1 through 7, further comprising: training a multi-stage semantic understanding model comprising: training a single frame appearance understanding, the single frame appearance understanding aligning images and text pairs; training a multi-frame understanding, the multi-frame understanding using simulated video to align the simulated video with corresponding text; training a long video storyline understanding; and tuning the model using downstream task instruction templates.

Embodiment 9 is a system comprising: one or more computers and one or more storage devices storing instructions that are operable, when executed by the one or more computers, to cause the one or more computers to perform the method of any one of embodiments 1 to 8.

Embodiment 10 is a computer storage medium encoded with a computer program, the program comprising instructions that are operable, when executed by data processing apparatus, to cause the data processing apparatus to perform the method of any one of embodiments 1 to 8.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures, such as spreadsheets, relational databases, or structured files, may be used.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A method comprising:
obtaining a video;
extracting frames from the video;
encoding the extracted frames;
extracting multimodal features including encoding speech content from the video as a text modality;
encoding spatiotemporal dependencies between the extracted frames and aligned multi-modal features;
providing the encoded temporal dependencies to a language model (LM) that learns spatiotemporal understanding of the entire video content; and
using the language model to respond to user queries about the content of the video.

2. The method of claim 1, wherein extracting frames from the video comprises separating the video into a plurality of scenes and sampling one or more frames from each scene.

3. The method of claim 1, wherein encoding the extracted frames comprises, for each frame:
applying a visual encoder to encode the frame into a set of tokens; and
applying a query transformer to generate a representation of the frame encoding having a reduced number of tokens.

4. The method of claim 1, further comprising:
adding timestamp information to each video frame encoding and text encoding of speech content, the video frame encoding including a first encoding indicating an absolute time associated with the video frame and a relative time indicating a location of the video frame relative to the entire video.

5. The method of claim 1, wherein encoding temporal dependencies comprises:
applying a hierarchical attention model comprising:
a first attention layer performing intra-frame attention that calculates correlations between tokens of a frame;
a second attention layer performing inter-frame attention that calculates correlations between adjacent frames; and
a third attention layer performing gateway attention that calculates correlations between adjacent super frames.

6. The method of claim 1, wherein providing the encoded temporal dependencies to the language model further comprises:
applying a neural network model that modally aligns spatiotemporal encoding tokens with LM text tokens.

7. The method of claim 1, wherein providing the encoded temporal dependencies to the language model further comprises providing one or more editing tasks corresponding to user downstream tasks to the LM along with the encoded temporal dependencies.

8. The method of claim 1, further comprising:
training a multi-stage semantic understanding model comprising:
training a single frame appearance understanding, the single frame appearance understanding aligning images and text pairs;
training a multi-frame understanding, the multi-frame understanding using simulated video to align the simulated video with corresponding text;
training a long video storyline understanding; and
tuning the model using downstream task instruction templates.

9. A system comprising:
one or more computers and one or more storage devices storing instructions that are operable, when executed by the one or more computers, to cause the one or more computers to perform operations comprising:
obtaining a video;
extracting frames from the video;
encoding the extracted frames;
extracting multimodal features including encoding speech content from the video as a text modality;
encoding spatiotemporal dependencies between the extracted frames and aligned multi-modal features;
providing the encoded temporal dependencies to a language model (LM) that learns spatiotemporal understanding of the entire video content; and
using the large language model to respond to user queries about the content of the video.

10. The system of claim 9, wherein extracting frames from the video comprises separating the video into a plurality of scenes and sampling one or more frames from each scene.

11. The system of claim 9, wherein encoding the extracted frames comprises, for each frame:
applying a visual encoder to encode the frame into a set of tokens; and
applying a query transformer to generate a representation of the frame encoding having a reduced number of tokens.

12. The system of claim 9, wherein the instructions are further operable to cause the one or more computers to perform operations comprising:
adding timestamp information to each video frame encoding and text encoding of speech content, the video frame encoding including a first encoding indicating an absolute time associated with the video frame and a relative time indicating a location of the video frame relative to the entire video.

13. The system of claim 9, wherein encoding temporal dependencies comprises:
applying a hierarchical attention model comprising:
a first attention layer performing intra-frame attention that calculates correlations between tokens of a frame;
a second attention layer performing inter-frame attention that calculates correlations between adjacent frames; and
a third attention layer performing gateway attention that calculates correlations between adjacent super frames.

14. The system of claim 9, wherein providing the encoded temporal dependencies to the language model further comprises:
applying a neural network model that modally aligns spatiotemporal encoding tokens with LM text tokens.

15. The system of claim 9, wherein providing the encoded temporal dependencies to the language model further comprises providing one or more editing tasks corresponding to user downstream tasks to the LM along with the encoded temporal dependencies.

16. The system of claim 9, wherein the instructions are further operable to cause the one or more computers to perform operations comprising:
training a multi-stage semantic understanding model comprising:
training a single frame appearance understanding, the single frame appearance understanding aligning images and text pairs;
training a multi-frame understanding, the multi-frame understanding using simulated video to align the simulated video with corresponding text;
training a long video storyline understanding; and
tuning the model using downstream task instruction templates.

17. One or more computer-readable storage media encoded with instructions that, when executed by one or more computers, cause the one or more computers to perform operations comprising:
obtaining a video;
extracting frames from the video;
encoding the extracted frames;
extracting multimodal features including encoding speech content from the video as a text modality;
encoding spatiotemporal dependencies between the extracted frames and aligned multi-modal features;
providing the encoded temporal dependencies to a language model (LM) that learns spatiotemporal understanding of the entire video content; and
using the large language model to respond to user queries about the content of the video.

18. The computer-readable storage media of claim 17, wherein extracting frames from the video comprises separating the video into a plurality of scenes and sampling one or more frames from each scene.

19. The computer-readable storage media of claim 17, wherein encoding the extracted frames comprises, for each frame:
applying a visual encoder to encode the frame into a set of tokens; and
applying a query transformer to generate a representation of the frame encoding having a reduced number of tokens.

20. The computer-readable storage media of claim 17 further comprising instructions that cause the one or more computers to perform operations comprising:
adding timestamp information to each video frame encoding and text encoding of speech content, the video frame encoding including a first encoding indicating an absolute time associated with the video frame and a relative time indicating a location of the video frame relative to the entire video.
